(19) United States
(12) Patent Application Publication
(10) Pub. No.: US 2017/0313190 A1
(43) Pub. Date: Nov. 2, 2017

(54) METHOD OF CONTROLLING ALERTING DRIVER, ALERTING CONTROL DEVICE, DRIVING SUPPORT METHOD, DRIVING SUPPORT DEVICE, AND COMPUTER-READABLE RECORDING MEDIUM

(71) Applicant: FUJITSU LIMITED, Kawasaki-shi (JP)

(72) Inventors: Takashi Shimada, Shinagawa (JP); Kimio Kikuchi, Yokosuka (JP); Yujin Kikkawa, Meguro (JP); Masatsugu Isogai, Yokohama (JP); Kazuhiro Sakai, Shibuya (JP); Shun Matsumoto, Shibuya (JP)

(73) Assignee: FUJITSU LIMITED, Kawasaki-shi (JP)

(21) Appl. No.: 15/649,135

(22) Filed: Jul. 13, 2017

Related U.S. Application Data
(63) Continuation of application No. PCT/JP2016/051049, filed on Jan. 14, 2016.

(30) Foreign Application Priority Data
Jan. 15, 2015 (JP) 2015-006258

(51) Int. Cl. B60K 28/06; G08B 21/06; B60Q 5/00

(52) U.S. Cl. CPC B60K 28/066; B60Q 5/005; G08B 21/06

(57) ABSTRACT

A non-transitory computer-readable recording medium stores a driving support program that causes a computer to execute a process including: collecting vital sign information on a user from a vital sign measuring device; generating a drowsiness occurrence time pattern with respect to the user based on the collected vital sign information; and in response to a request in which a driver is specified from a source of the request, providing the drowsiness occurrence time pattern that is generated with respect to the user corresponding to the driver to the source of the request to the source of request or providing alerting information to the driver that is determined according to the drowsiness occurrence time pattern generated with respect to the user corresponding to the driver to the source of request.

### CROSS-REFERENCE TO RELATED APPLICATION

This application is a continuation application of International Application No. PCT/JP2016/051049 filed on Jan. 14, 2016 which claims the benefit of priority of the prior Japanese Patent Application No. 2015-006258, filed on Jan. 15, 2015, the entire contents of which are incorporated herein by reference.

### FIELD

The embodiments discussed herein are related to a method of controlling alerting a driver, an alerting control device, a driving support method, a driving support device, and a computer-readable recording medium.

### BACKGROUND

A technology has been proposed in which biological information, such as pulses of a driver who is driving, is measured and an alert is made when drowsiness is detected from variation in the biological information.

Patent Document 1: Japanese Laid-open Patent Publication No. 2005-46306

Patent Document 2: Japanese Laid-open Patent Publication No. 05-184558

A situation where drowsiness is detected by using the related technology is a situation where drowsiness is caused in a driver and it is dangerous to drive. Accidents are thus not necessarily prevented from occurring.

### SUMMARY

According to an aspect of the embodiments, a non-transitory computer-readable recording medium stores a driving support program that causes a computer to execute a process including: collecting vital sign information on a user from a vital sign measuring device; generating a drowsiness occurrence time pattern with respect to the user based on the collected vital sign information; and in response to a request in which a driver is specified from a source of the request, providing the drowsiness occurrence time pattern that is generated with respect to the user corresponding to the driver to the source of the request to the source of request or providing alerting information to the driver that is determined according to the drowsiness occurrence time pattern generated with respect to the user corresponding to the driver to the source of request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an illustration diagram illustrating an exemplary system configuration;

FIG. 2 is an illustration diagram illustrating a driving monitoring device;

FIG. 3 is an illustration diagram illustrating and exemplary data configuration of driving information;

FIG. 4 is an illustration diagram illustrating an exemplary data configuration of status information;

FIG. 5 is an illustration diagram illustrating an exemplary data configuration of biological rhythm information;

FIG. 6 is an illustration diagram illustrating an exemplary data configuration of estimated time information;

FIG. 7 is an illustration diagram illustrating an exemplary data configuration of practice standards information;

FIG. 8 is an illustration diagram illustrating an exemplary measuring device;

FIG. 9 is an illustration diagram illustrating an exemplary data configuration of measurement information;

FIG. 10 is an illustration diagram illustrating an exemplary driving management server;

FIG. 11 is an illustration diagram illustrating exemplary variation in the alertness level;

FIG. 12 is an illustration diagram illustrating an exemplary change in the drowsiness level;

FIG. 13 is an illustration diagram illustrating an example where variation the drowsiness is calculated;

FIG. 14 is an illustration diagram illustrating an example where variation in drowsiness is calculated;

FIG. 15 is an illustration diagram illustrating an exemplary flow of control on alerting;

FIG. 16 is a flowchart illustrating an exemplary procedure of a transmission process;

FIG. 17 is a flowchart illustrating an exemplary procedure of a request process;

FIG. 18 is a flowchart illustrating an exemplary procedure of a generation process;

FIG. 19 is a flowchart illustrating an exemplary procedure of an alerting control process;

FIG. 20 is an illustration diagram illustrating another exemplary flow of control on alerting;

FIG. 21 is an illustration diagram illustrating an exemplary configuration of a computer that executes an alerting control program; and

FIG. 22 is an illustration diagram illustrating an exemplary configuration of a computer that executes a driving support program.

### DESCRIPTION OF EMBODIMENT

Preferred embodiments will be explained with reference to accompanying drawings. The embodiments do not limit the technology disclosed herein. The embodiments to be described below may be combined as appropriate as long as discrepancy is not caused.

### [a] First Embodiment

System Configuration

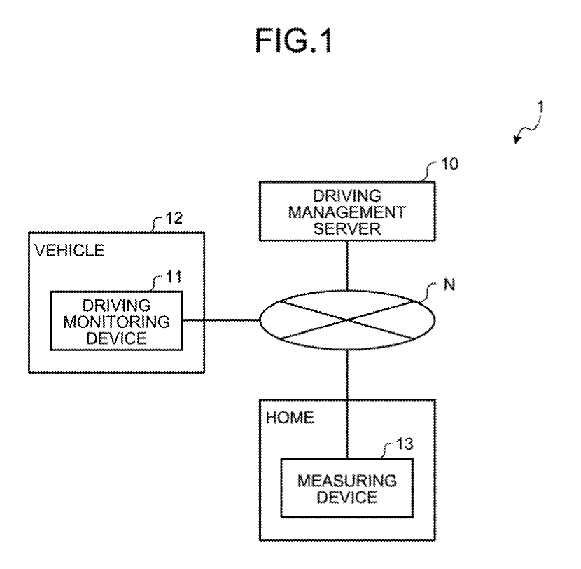

For example, in the transportation industry, driving monitoring devices that monitor the driving status are mounted on operation vehicles and driving management is performed according to the information collected from the driving monitoring devices. An exemplary case where a system that performs driving management is used will be described as an embodiment. An exemplary system that performs driving management according to the first embodiment will be described. FIG. 1 is an illustration diagram illustrating an exemplary system configuration. As illustrated in FIG. 1, a system 1 includes a driving management server 10, a driving monitoring device 11, and a measuring device 13. The driving management server 10, the driving monitoring device 11, and the measuring device 13 are connected to a network N such that they can communicate with one another. Any type of communication network, such as mobile communication using, for example, a mobile phone, the Internet, a local area network (LAN) or a virtual private network (VPN), may be used as a mode of the network N.

The driving monitoring device 11 is, for example, a device that is mounted on the driver's seat of a vehicle and monitors the driving of the vehicle on which the driving monitoring device 11 is mounted. The driving monitoring device 11 is mounted on a vehicle 12. The example illustrated in FIG. 1 exemplifies the case where the driving monitoring device 11 is mounted on the single vehicle 12; however, the embodiments are not limited thereto, and any number of the vehicles 12 may be used.

The driving management server 10 is a device that manages driving. The driving management server 10 is, for example, a computer, such as a personal computer or a server computer. The driving management server 10 may be implemented with a single computer or with multiple computers. The embodiment will be described exemplarily as the case where the driving management server 10 is a single computer.

The driving management server 10 performs driving management. For example, the driving management server 10 collects various types of information on the driver, which are acquired by the driving monitoring device 11, via the network N. The driving management server 10 manages the driving of the vehicle 12 according to the collected information. The example illustrated in FIG. 1 exemplifies the case where various types of information are collected from the driving monitoring device 11 via the network N; however, the embodiments are not limited thereto. For example, the driving management server 10 may collect the various types of information acquired by the driving monitoring device 11 via, for example, a storage medium, such as a flash memory. Alternatively, for example, the driving management server 10 may collect the various types of information acquired by the driving monitoring device 11 by wired or wireless communication with the driving monitoring device 11.

The measuring device 13 is, for example, a device that is arranged at the homes of various types of users including drivers and measures various types of biological information on the users. For example, the measuring device 13 is a sleep meter that measures a wake-up time and a time at which a sleep starts as biological information. The measuring device 13 receives a user ID and registration of a transmission destination. The measuring device 13 transmits the measured biological information to the registered transmission destination. The measuring device 13 may transmit the biological information to a terminal device that is able to communicate with the network N, such as a mobile phone or a smartphone, via a storage medium or by wired or wireless communication and the terminal device may transmit the biological information to the transmission destination. In other words, the biological information measured by the measuring device 13 may be transmitted to the driving management server 10 via the terminal device.

Configuration of Driving Monitoring Device

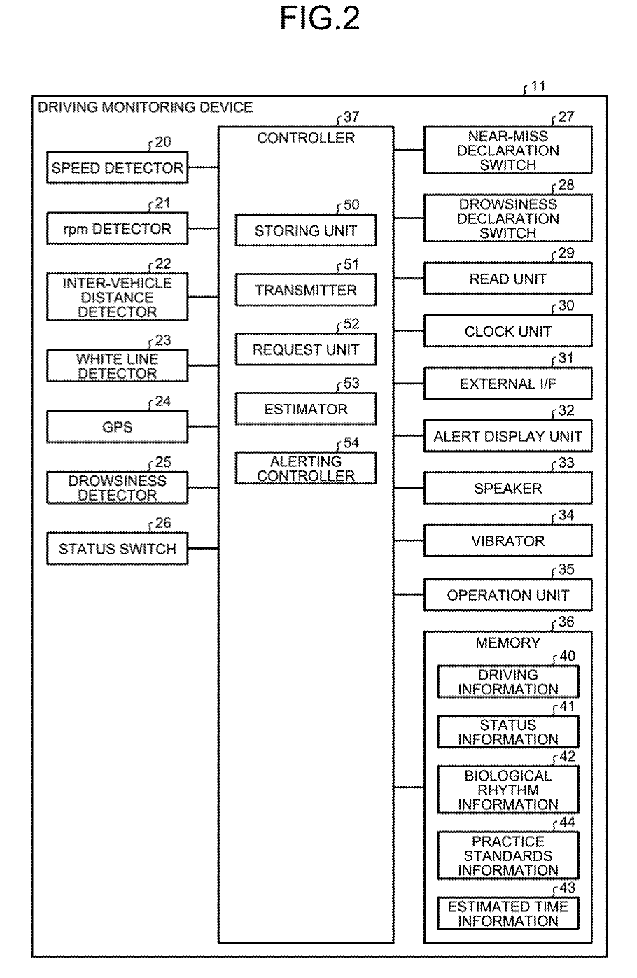

The configuration of each device will be described. First of all, the configuration of the driving monitoring device 11 will be described. FIG. 2 is an illustration diagram illustrating an exemplary driving monitoring device. The driving monitoring device 11 illustrated in FIG. 2 includes a speed detector 20, an rpm detector 21, an inter-vehicle distance detector 22, a white line sensor 23, and a global positioning system (GPS) 24. The driving monitoring device 11 includes a drowsiness detector 25, a status switch 26, a near-miss declaration switch 27, a drowsiness declaration switch 28, a read unit 29, a clock unit 30, and an external interface (I/F) 31. The driving monitoring device 11 further includes an alert display unit 32, a speaker 33, a vibrator 34, an operation unit 35, a storage unit 36, and a controller 37.

The speed detector 20 is a detector that detects the speed of the vehicle. For example, the speed detector 20 detects the speed at which the vehicle travels based on signals from the speed sensor that is provided in the vehicle. The rpm detector 21 is a detector that detects revolutions per minute (rpm). For example, the rpm detector 21 detects the rpm of the engine based on a signal of engine ignition pulse. The inter-vehicle distance detector 22 is a detector that detects the distance between vehicles. For example, the inter-vehicle distance detector 22 detects the distance to the preceding vehicle based on the result of detection by a laser sensor or a millimeter wave radar sensor that is provided on the front side of the vehicle. The white line sensor 23 is a sensor that senses deviation of the vehicle from the white line. For example, the white line sensor 23 detects a white line of the lane by analyzing an image captured by a camera facing forward with respect to the vehicle and senses deviation of the vehicle from the white line. The GPS 24 measures the current position of the vehicle based on signals from a GPS satellite. The drowsiness detector 25 is a detector that detects occurrence of drowsiness. For example, the drowsiness detector 25 analyzes fluctuation in pulses of the driver measured by an earring-shaped contact-type pulse measurement unit to be worn on an ear or a contactless-type pulse measurement unit and senses drowsiness of the driver. Pulses may be detected by using a method other than direct contact methods. For example, the drowsiness detector 25 may apply electric waves to the driver and detect variation in reflection of the electric waves to detect pulses of the driver.

The status switch 26 is, for example, a switch that specifies the status of the driver of the vehicle. The status switch 26 is, for example, a switch that specifies a status, such as driving, loading, unloading, resting or sleeping. The near-miss declaration switch 27 is, for example, a switch that is operated when the driver of the vehicle being driven is aware of a near miss. The drowsiness declaration switch 28 is, for example, a switch that is operated when the driver of the vehicle being driven is aware of drowsiness. The read unit 29, for example, executes contactless IC communication with a contactless IC card in which the user Identification (ID) is stored and reads the user ID stored in the contactless IC card to acquire the user ID. For example, a driver's license card may be used as the contactless IC card. Personal information, such as a driver's license card number stored in a driver's license card may be used as the user ID. For example, the read unit 29 executes contactless IC communication with a driver's license card, reads the personal information in the driver's license card, and acquires the read personal information as a user ID.

The clock unit 30 is a clock indicating the time and date in the driving monitoring device 11. The external I/F 31 is, for example, an interface that transmits and receives various types of information to and from other devices. In the driving monitoring device 11, the external I/F 31 is a wireless communication interface that performs wireless communication with the network N. When the driving monitoring device 11 transmits and receives various types of information to and from the driving management server 10 via a storage medium, the external I/F 31 serves as a port that inputs and outputs data to and from the storage medium. When the driving monitoring device 11 transmits and receives various types of information by wired or wireless communication to and from the driving management server 10, the external I/F 31 servers as a communication interface that performs wired or wireless communication.

The alert display unit 32 is a device that displays various alerts. For example, the alert display unit 32 is a display device, such as a liquid crystal display, that is set in a position such that the display device is viewable by the driver on the driver's seat of the vehicle 12. The alert display unit 32 may be, for example, an alert lamp. The speaker 33 is a device that makes an alert by sound. For example, the speaker 33 is a device that is set in the vehicle 12 and that is able to output sound, such as an alert sound. The vibrator 34 is a device that makes an alert by vibration. For example, the vibrator 34 is a device that is able to vibrate and that is provided to a part where the vibrator 34 contacts the driver, such as the steering wheel or the driver's seat of the vehicle 12. The operation unit 35 is an input device that receives various operational inputs.

The storage unit 36 is a storage device, such as a hard disk, a solid state drive (SSD), or an optical disk. The storage unit 36 may be a data-rewritable semiconductor memory, such as a random access memory (RAM), a flash memory, or a non-volatile static random access memory (NVSRAM). The storage unit 36 stores an operating system (OS) and various types of programs that are executed by the controller 37. Furthermore, the storage unit 36 stores various types of information. For example, the storage unit 36 stores driving information 40, status information 41, biological rhythm information 42, estimated time information 43, and practice standards information 44.

The driving information 40 is data in which various types of information on the driving of the vehicle are stored. In the driving information 40, various types of data detected respectively by the speed detector 20, the rpm detector 21, the inter-vehicle distance detector 22, the white line sensor 23, and the GPS 24 are stored.

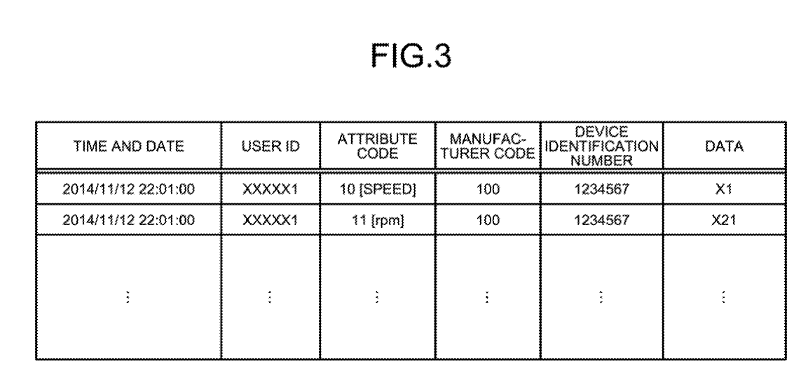

FIG. 3 is an illustration diagram illustrating an exemplary data configuration of the driving information. As illustrated in FIG. 3, the driving information 40 has columns of time and date, user ID, attribute code, manufacturer code, device identification number, and data. The time and date column is an area in which the time and date when data is detected is stored. The user ID column is an area in which the identification information of the driver who drives the vehicle is stored. In the user ID column, the user ID of the driver that is read by the read unit 29 is stored. The attribute code column is an area in which identification information representing the type of the detected data is stored. The manufacturer of the driving monitoring device 11 determines individual attribute codes each representing a type with respect to the various types of data to be detected. Each manufacturer may use the same attribute code for the same type of data or different attribute codes. In the example illustrated in FIG. 3, the speed attribute code is determined as “10” and the rpm attribute code is determined as “11”. In the attribute-code column, an attribute code representing the attribute of detected data is stored. In order to easily distinguish between attributes corresponding to attribute codes, the attribute represented by an attribute code is represented in the brackets [ ] following the attribute code in the drawing of the embodiment. In the example illustrated in FIG. 3, the attribute is represented in the brackets [ ] following the attribute code in the attribute code column. The manufacturer code column is an area in which the identification information that identifies the manufacturer of the driving monitoring device 11 is stored. A unique manufacturer code is assigned to the manufacturer of the driving monitoring device 11 as identification information that identifies each manufacturer. In the manufacturer code column, a manufacturer code assigned to the manufacturer of the driving monitoring device 11 is stored. The device identification number column is an area in which identification information that identifies the driving monitoring device 11 is stored. A unique device identification number is assigned to the driving monitoring device 11 as identification information that identifies the driving monitoring device 11 according to each manufacturer. In the device identification number column, a device identification number assigned to the driving monitoring device 11 is stored. The data column is a column in which detected data is stored. In the data column, detected data is stored. For example, when the attribute is speed, a value of speed per hour [km/h] is stored in the data column. When the attribute is rpm, the number of revolutions per minute [rpm] is stored in the data column. When the attribute is inter-vehicle distance, the value of the distance [m] is stored in the data column. In the case where the attribute is white line deviation, when the white line sensor 23 senses deviation from the white line, “1” is stored in the data column. When the attribute is position measured by the GPS 24, positional information measured by the GPS 24 is stored in the data column.

The example illustrated in FIG. 3 illustrates that the driver whose user ID is “XXXXX1” drives the vehicle 12, the manufacturer code of the manufacturer of the driving monitoring device 11 is “100”, and the device identification number of the driving monitoring device 11 is “1234567”. The example illustrated in FIG. 3 further illustrates that the speed is detected at 22:01:00 on Nov/12/2014, and the detected speed is X1 [km/h]. The example illustrated in FIG. 3 further illustrates that the rpm is detected at 22:01:00 on Nov/12/2014, and the detected rpm is X21 [rpm].

The status information 41 is data in which various types of information on the status of the driver is stored. Various types of data detected respectively by the drowsiness detector 25, the status switch 26, the near-miss declaration switch 27, and the drowsiness declaration switch 28 are stored in the status information 41.

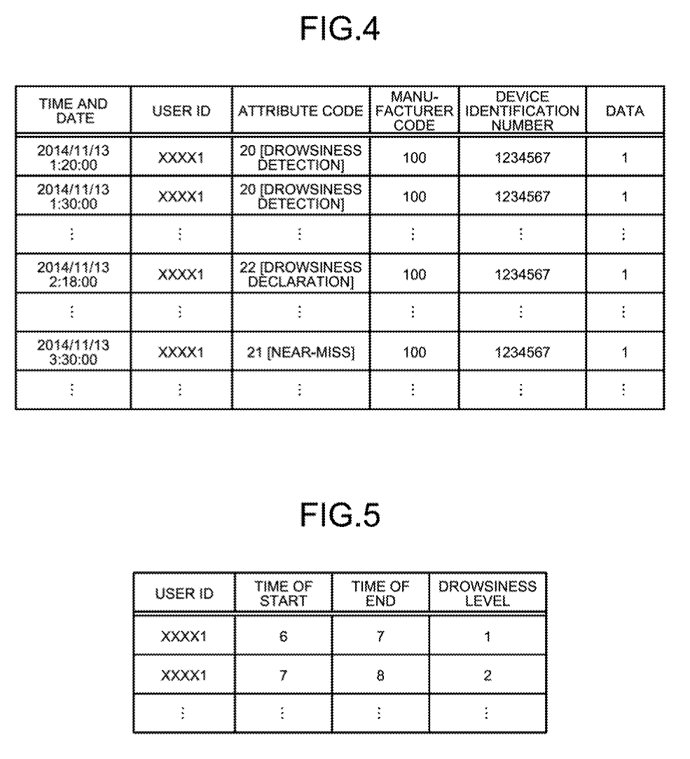

FIG. 4 is an illustration diagram illustrating an exemplary data configuration of the status information. The status information 41 has the same data configuration as that of the driving information 40. In the example illustrated in FIG. 4, the attribute code of drowsiness detection by the drowsiness detector 25 is determined as “20”, the attribute code of near-miss declaration by the near-miss declaration switch 27 is determined as “21”, the attribute code of drowsiness declaration by the drowsiness declaration switch 28 is determined as “22”. In the attribute code column, an attribute code representing the attribute of detected data is stored. In the date column, the detected data is stored. For example, in the case where the attribute is drowsiness detection, when the drowsiness detector 25 detects drowsiness, “1” is stored in the data column. In the case where the attribute is driving status, the value corresponding to the status according to the status switch 26 is stored in the data column. In the case where the attribute is near-miss declaration, when the near-miss declaration switch 27 is turned on, “1” is stored in the data column. In the case where the attribute is drowsiness declaration, when the drowsiness declaration switch 28 is turned on, “1” is stored in the data column.

The example illustrated in FIG. 4 illustrates that the driver whose user ID is “XXXXX1” drives the vehicle 12, the manufacturer code of the manufacturer of the driving monitoring device 11 is “100”, and the device identification number of the driving monitoring device 11 is “1234567”. The example illustrated in FIG. 4 further illustrates that drowsiness is detected by the drowsiness detector 25 at 01:20:00 on Nov/13/2014. The example illustrated in FIG. 4 further illustrates that drowsiness is detected by the drowsiness detector 25 at 01:30:00 on Nov/13/2014. The example illustrated in FIG. 4 further illustrates that drowsiness declaration is made by the drowsiness declaration switch 28 at 02:18:00 on Nov/13/2014. The example illustrated in FIG. 4 further illustrates that near-miss declaration is detected by the near-miss declaration switch 27 at 03:30:00 on Nov/13/2014. The data configurations of the driving information 40 and the status information 41 illustrated in FIGS. 3 and 4 are examples only and thus the embodiments are not limited thereto. For example, the driving information 40 and the status information 41 may be in a single file. The driving information 40 and the status information 41 may be in different files according to the data attributes. Furthermore, the driving information 40 and the status information 41 may have a data configuration where sets of data of respective columns are sectioned by using predetermined sectioning letters according to a predetermined order. The driving information 40 and the status information 41 may have a data configuration representing data attributes by using, for example, tags.

The biological rhythm information 42 is data in which information on the biological rhythm relating to sleep of the driver is stored. For example, the levels of drowsiness to occur, respectively corresponding to the elapsed times from a wake-up of the driver, are stored in the biological rhythm information 42.

FIG. 5 is an illustration diagram illustrating an exemplary data configuration of the biological rhythm information. As illustrated in FIG. 5, the biological rhythm information 42 has columns of user ID, time of start, time of end, and drowsiness level. The user ID column is an area in which a user ID is stored. The start time column is an area in which a time when an elapsed time according to which drowsiness at a drowsiness level occurs starts is stored. The end time column is an area in which a time when the elapsed time according to which drowsiness at the drowsiness level occurs ends is stored. The drowsiness level column is an area in which the level of drowsiness to occur is stored. The higher the drowsiness level is, the more drowsiness tends to be caused.

The example illustrated in FIG. 5 illustrates that drowsiness at a drowsiness level 1 occurs to the driver whose user ID is “XXXXX1” between the elapsed time of 6 hours and the elapsed time of 7 hours. The example illustrated in FIG. 5 further illustrates that drowsiness at a drowsiness level 2 occurs to the driver whose user ID is “XXXXX1” during the elapsed time of 7 hours and the elapsed time of 8 hours.

The estimated time information 43 is data in which information on occurrence of drowsiness is stored. For example, a time at which drowsiness occurs to the driver and the level of drowsiness to occur are stored in the estimated time information 43.

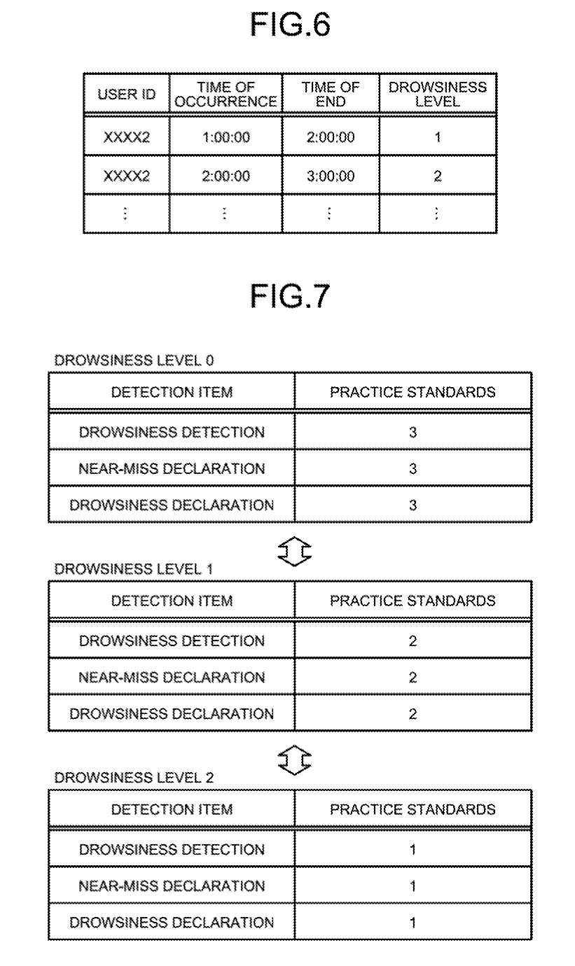

FIG. 6 is an illustration diagram illustrating an exemplary data configuration of the estimated time information. As illustrated in FIG. 6, the estimated time information 43 includes columns of user ID, time of occurrence, time of end, and drowsiness level. The user ID column is an area in which a user ID is stored. The time-of-occurrence column is an area in which an estimated time at which drowsiness at a drowsiness level occurs is stored. The time-of-end column is an area in which an estimated time when drowsiness at a drowsiness level ends is stored. The drowsiness level column is an area in which a drowsiness level representing the level of drowsiness to occur is stored.

The example illustrated in FIG. 6 illustrates that drowsiness at a drowsiness level 1 will occur in the driver whose user ID is “XXXXX1” between 1 o'clock and 2 o'clock. The example illustrated in FIG. 6 further illustrates that drowsiness at a drowsiness level 2 occurs to the driver whose user ID is “XXXXX1” between 2 o'clock and 3 o'clock.

Practice standards information 44 is data in which information on practice standards for alerting the driver is stored. For example, in the practice standards information 44, a threshold serving as practice standards for alerting according to the number of times drowsiness is detected within a predetermined time and the number of times a near-miss is declared and drowsiness is declared is stored. The predetermined time is, for example, one hour. The practice standards stored in the practice standards information 44 are updated according to the drowsiness level.

FIG. 7 is an illustration diagram illustrating an exemplary data configuration of the practice standards information. As illustrated in FIG. 7, the practice standards information 44 has columns of detection item and practice standards. The detection item column is an area in which a data item that is focused for alerting is stored. The practice standards column is an area in which a threshold for alerting is stored.

In the example illustrated in FIG. 7, with respect to a drowsiness level 0, 3 (three times) is the threshold for detection of drowsiness, declaration of a near-miss and declaration of drowsiness. With respect to a drowsiness level 1, 2 (twice) is the threshold for detection of drowsiness, declaration of a near-miss and declaration of drowsiness. With respect to a drowsiness level 2, 1 (once) is the threshold for detection of drowsiness, declaration of a near-miss and declaration of drowsiness. The values of thresholds represented in FIG. 7 are examples only and the embodiments are not limited thereto.

The controller 37 controls the entire driving monitoring device 11. For the controller 37, an electronic circuit, such as a central processing unit (CPU) or a micro processing unit (MPU), or an integrated circuit, such as an application specific integrated circuit (ASIC) or a field programmable gate array (FPGA), can be used. The controller 37 includes an internal memory for storing programs that define various process procedures and control data. The controller 37 executes the various processes according to the programs and control data. Various programs run and accordingly the controller 37 functions as various processors. For example, the controller 37 includes a storing unit 50, a transmitter 51, a request unit 52, an estimator 53, and an alerting controller 54.

The storing unit 50 stores various types of data detected respectively by the speed detector 20, the rpm detector 21, the inter-vehicle distance detector 22, and the white line sensor 23 in the driving information 40. the storing unit 50 further stores various types of data that are detected respectively by the drowsiness detector 25, the status switch 26, the near-miss declaration switch 27, and the drowsiness declaration switch 28 in the status information 41.

The transmitter 51 transmits the driving information 40 and the status information 41 at a predetermined timing to the driving management server 10.

The request unit 52 specifies the user ID of the driver that is acquired by the read unit 29 and transmits a request to transmit the biological rhythm information 42 to the driving management server 10. On receiving the transmission request, the driving management server 10 transmits the biological rhythm information 42 to the driving monitoring device 11. The request unit 52 stores the biological rhythm information 42 that is transmitted from the driving management server 10 in the storage unit 36.

The estimator 53 estimates a time at which drowsiness will occur based on the biological rhythm information 42 that is stored in the storage unit 36. For example, the estimator 53 calculates a time after the elapsed time from the driver's wake-up time with respect to each record stored in the biological rhythm information 42. For example, the estimator 53 calculates a time at which the following drowsiness occurs and a time at which the drowsiness ends according to a time of start and a time of end that are elapsed times from the driver's wake-up time. The estimator 53 then stores the calculated time of occurrence and time of end and the drowsiness level in association with one another in the estimated time information 43. The estimated time information 43 is the result of the calculating of the biological rhythm information 42 illustrated in FIG. 5 by the estimator 53 when the wake-up time is 19:00:00 on Nov/12/2014. The driver's wake-up time may be input from the operation unit 35 or may be notified from the driving management server 10.

The alerting controller 54 performs various types of control on alerting. The alerting controller 54 performs various types of control on alerting in order to prevent the occurrence of accident at a time before the time at which drowsiness occurs or at the time at which drowsiness occurs.

For example, the alerting controller 54 executes control to cause an output of an alert to the driver. For example, the alerting controller 54 displays an alerting message on the alert display unit 32. The alerting controller 54 outputs an alert sound from the speaker 33. The alerting controller 54 also alerts the driver by causing the vibrator 34 to vibrate for tactile stimulation.

For example, the alerting controller 54 performs control to moderate the practice standards to output an alert. For example, the alerting controller 54 updates the practice standards stored in the practice standards information 44 according to the drowsiness level. When an abnormality satisfying the updated practice standards is detected, the alerting controller 54 outputs an alert. For example, as the drowsiness level is 1 between 1 o'clock and 2 o'clock, the alerting controller 54 updates the threshold for near-miss declaration and drowsiness declaration to 2 (twice) as illustrated in FIG. 7. When drowsiness is detected twice between 1 o'clock and 2 o'clock as illustrated in FIG. 4, the alerting controller 54 outputs an alert. For example, as the drowsiness level is 2 between 2 o'clock and 3 o'clock, the alerting controller 54 updates the threshold for drowsiness detection, near-miss declaration, and drowsiness declaration to 1 (once) as illustrated in FIG. 7. When drowsiness is declared once between 2 o'clock and 3 o'clock as illustrated in FIG. 4, the alerting controller 54 outputs an alert illustrated in FIG. 4.

For example, the alerting controller 54 performs control to increase the level of outputting an alert. For example, when an alert is made, the alerting controller 54 enhances the alert display by changing the background color and the size of texts displayed on the alert display unit 32 such that the texts are highly visible or by causing the alert display to blink. When an alert is made, the alerting controller 54 enhances the alert sound by increasing the volume of alert sound that is output from the speaker 33, increasing the tone of the alert sound, or increasing the time during which the alert sound is output. When an alert is made, the alerting controller 54 increases the tactile stimulation for alerting by causing the vibrator 34 to vibrate strongly.

The alerting controller 54 may selectively execute any one or two types of control to output an alert to the driver, control to attenuate the practice standards for outputting an alert, and control to increase the level of outputting an alert. A time before the time of occurrence of drowsiness is defined as a time a predetermined time before the time of occurrence of drowsiness. The predetermined time may be, for example, a certain time, such as ten minutes. For example, the time may be variable within a predetermined range between, for example, five to thirty minutes, according to the driver's status such that, for example, the higher the level of drowsiness of the driver is, the shorter the period is. The predetermined time may be changed from the outside. For example, when the time of occurrence of drowsiness is one o'clock and the predetermined time is ten minutes, the time the predetermined time before the time of occurrence is 00:50.

As described above, the driving monitoring device 11 controls alerting and thus is able to make an alert before drowsiness occurs to the driver, which enables prevention of occurrence of accidents.

Configuration of Measuring Device

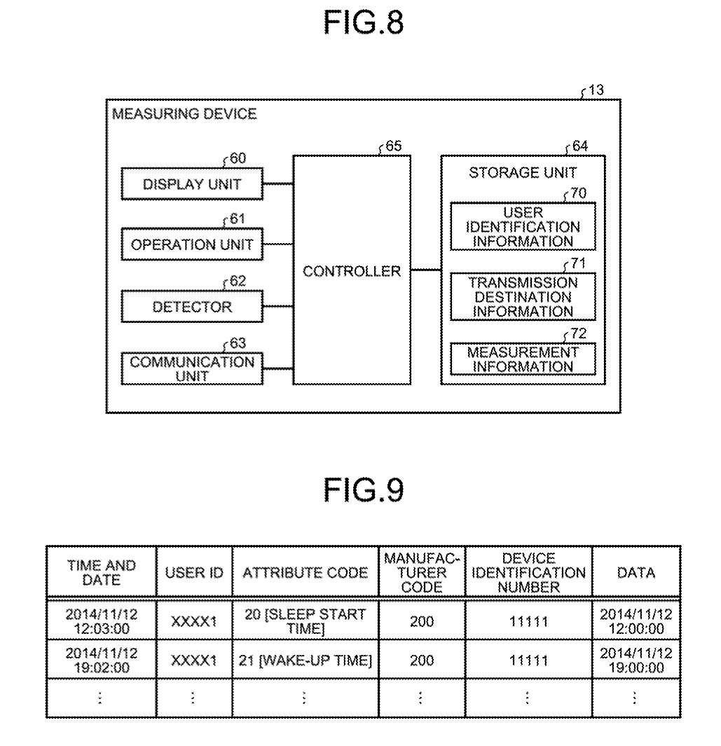

The configuration of the measuring device 13 will be descried. FIG. 8 is an illustration diagram illustrating an exemplary measuring device. The measuring device 13 illustrated in FIG. 8 includes the measuring device 13, a display unit 60, an operation unit 61, a detector 62, a communication unit 63, a storage unit 64 and a controller 65.

The display unit 60 is a display device capable of displaying various types of information. The operation unit 61 is an input device that receives various operational inputs. For example, the operation unit 61 receives a user ID and registration of a destination to which measured biological information is transmitted.

The detector 62 detects biological information on the user. For example, the detector 62 is a measurement unit that measures the time at which the user wakes up and the time at which the user starts sleeping. For example, the detector 62 detects variation in weighting with a pressure sensor that is provided to a bed and detects the time at which the weighting increases by a predetermined weight or more as a sleep start time when the user lies on the bed. The detector 62 also detects, as the wake-up time at which the user gets out of the bed, the time at which the weighting decreases by a predetermined weight or more after the sleep start time is detected. The wake-up time and the sleep start time may be measured by using another method. For example, the detector 62 may measure the amount of body motion by detecting vibration or by applying infrared or ultrasound and detecting variation in the reflection and then measure the wake-up time and the drowsiness start time from the amount of body motion. For example, the detector 62 may detect, as the sleep start time, a time at which the measured amount of body motion is within a standard range after the body motion within or over the standard range of standard body motion during sleep is detected. The detector 62 may detect, as the wake-up time, the time at which the amount of body motion is over a standard range of standard amount of body motion during sleep after the drowsiness start time is detected.

The communication unit 63 is, for example, a communication interface that implements wireless communication or wired communication with the network N. The storage unit 64 is a storage device, such as a hard disk, a SSD or an optical disk. The storage unit 64 may be a data-rewritable semiconductor memory. The storage unit 64 stores an OS and various programs that are executed by the controller 65. The storage unit 64 further stores various types of information. For example, the storage unit 64 stores user identification information 70, transmission destination information 71 and measurement information 72.

The user identification information 70 is data in which the user ID is stored. The transmission destination information 71 is data in which an address of a destination to which the detected biological information is to be transmitted. The address of the destination of transmission may be any information as long as the address represents the destination of transmission. For example the address of destination of transmission may be a network address, such as an Internet protocol (IP) address or may be a uniform resource locator (URL).

The measurement information 72 is data in which the biological information measured by the detector 62 is stored.

FIG. 9 is an illustration diagram illustrating an exemplary data configuration of the measurement information. The measurement information 72 has a data configuration similar to that of the driving information 40 and the status information 41, which are described above, and has columns of date, user ID, attribute code, manufacturer code, device identification number and data. In the date column, a date at which the detector 62 measures biological information is stored. In the user ID column, the user ID stored in the user identification information 70 is stored. In the attribute code column, an attribute code representing the attribute of the detected data is stored. The attribute code representing the type is individually determined with respect to various types of data for which the manufacture of the measuring device 13 is determined. According to the example illustrated in FIG. 9, the attribute code of the sleep start time is determined as “20” and the attribute code of the wake-up time is determined as “21”. In the manufacturer code column, a manufacturer code assigned to the manufacturer of the measuring device 13 is stored. In the device identification number column, the device identification number assigned to the measuring device 13 is stored. In the data column, the detected data is stored.

The example illustrated in FIG. 9 illustrates that the user biological information on the user whose user ID is “XXXXX1” is measured, the manufacturer code of the manufacturer of the measuring device 13 is “200”, and the device identification number of the measuring device 13 is “11111”. The example illustrated in FIG. 9 represents that the sleep start time is 12:00:00 on Nov/12/2014 and the wake-up time is 19:00:00 on Nov/12/2014.

The controller 65 controls the entire measuring device 13. For the controller 65, an electronic circuit, such as a CPU or a MPU, or an integrated circuit, such as an ASIC or a FPGA, may be used. The controller 65 receives the user ID and registration of an address of a destination of transmission from the operation unit 61. The controller 65 stores the registered user ID in the user identification information 70. The controller 65 further stores the registered address of the destination of transmission in the transmission destination information 71.

The controller 65 further stores the biological information that is detected by the detector 62 in the measurement information 72. For example, when the biological information is measured, the controller 65 stores the date of measurement, the attribute code of biological information, the user ID in the user identification information 70, the manufacturer code and the device identification number in association with one another in the measurement information 72. The controller 65 transmits the measured biological information to the transmission destination that is registered in the transmission destination information 71. For example, the controller 65 transmits the measurement information 72 to the address of the destination of transmission that is registered in the transmission destination information 71.

Configuration of Driving Management Server

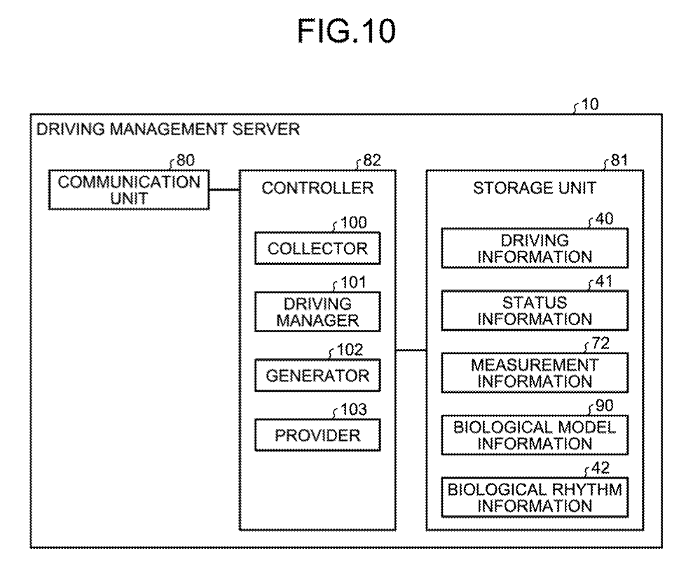

The configuration of the driving management server 10 will be described. FIG. 10 is an illustration diagram illustrating an exemplary driving management server. The driving management server 10 illustrated in FIG. 10 includes a communication unit 80, a storage unit 81, and a controller 82.

The communication unit 80 is, for example, a communication interface that implements wireless communication or wired communication with the network N. The storage unit 81 is a storage device, such as a hard disk, a SSD, or an optical disk. The storage unit 81 may be a data-rewritable semiconductor memory. The storage unit 81 stores an OS and various programs that are executed by the controller 82. The storage unit 81 also stores various types of information. For example, the storage unit 81 stores the driving information 40, the status information 41, the measurement information 72, biological model information 90, and the biological rhythm information 42.

The driving information 40 and the status information 41 are collected from the driving monitoring device 11 and stored. The measurement information 72 is collected from the measuring device 13 and stored. The biological model information 90 is data in which standards information for general drowsiness occurrence time pattern is stored.

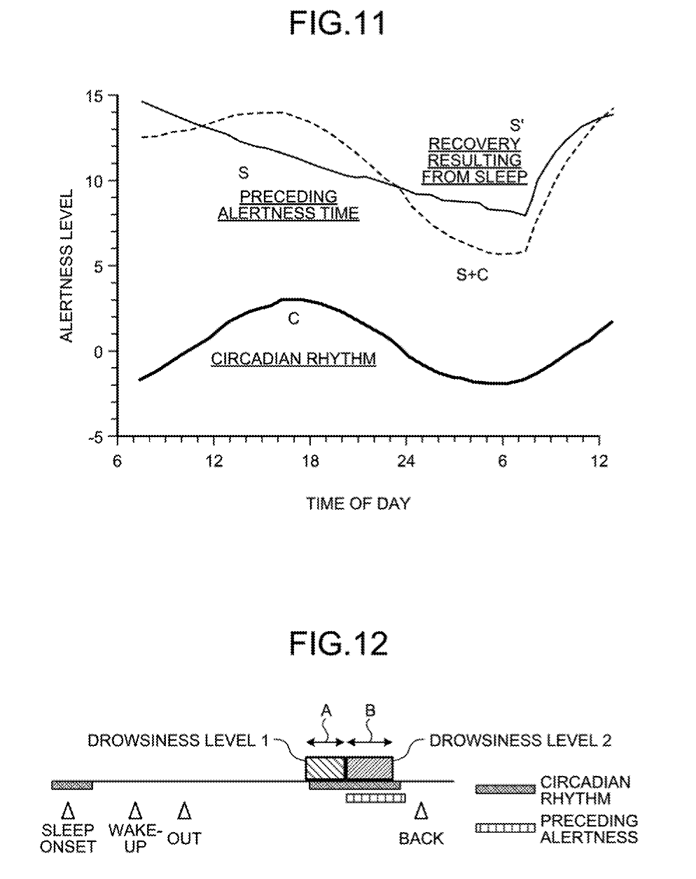

Occurrence of drowsiness will be described. FIG. 11 is an illustration diagram illustrating exemplary variation in the alertness level. The vertical axis in FIG. 11 represents the alertness level. The lower the alertness level is, the more drowsiness tends to be caused. The horizontal axis represents the time of day. FIG. 11 illustrates a circadian rhythm C representing general variation in the alertness level, a preceding alertness time S, and a recovery S′ representing a recovery resulting from sleep. The alertness level is further illustrated from a sleep inertia W that is a feeling of drowsiness that is caused on alertness from the sleep. The circadian rhythm C represents general variation in the alertness level according to the time of day. Human beings generally have a higher alertness level and thus do not tend to be drowsy in daytime and generally have a lower alertness level and thus tend to be drowsy in nighttime. The preceding alertness time S represents variation in the alertness level according to the elapsed time from the wake-up. In general, the alertness level of human beings lowers according to the elapsed time from the wake-up. The longer the elapsed time from the wake-up is, the more human beings tend to be drowsy. The preceding alertness time S′ represents variation in the alertness level from the wake-up in the morning where the alertness level lowers after the wake-up. The recovery S′ represents that the alertness level recovers because of sleep. The alertness level of human beings recovers because of sleep and, generally, the sleep inertia W representing an insufficient alertness occurs at the wake-up.

FIG. 11 illustrates, as S+C, a model of variation in the alertness level that is the combination of the circadian rhythm C, the preceding alertness time S, and the recovery S′ resulting from sleep. Note that the circadian rhythm C, the preceding alertness time S, and the recovery S′ resulting from sleep are exemplified as a model of variation in the alertness level; however, the embodiments are not limited thereto. Any model may be used for the model of variation in the alertness level as long as the model represents general variation in drowsiness. In the biological model information 90, data of a model representing the general variation in drowsiness is stored. For example, in the biological model information 90, the data of the model of the circadian rhythm C, the preceding alertness time S, and the recovery S′ resulting from sleep is stored. For example, in the biological model information 90, the data of the alertness level at each time of day is stored as the circadian rhythm C. In the biological model information 90, the data of the level of the decrease in the alertness level according to the elapsed time from the wake-up is also stored as the preceding alertness time S. Furthermore, in the biological model information 90, the data of the level of recovery of the alertness level according to the elapsed time from the wake-up is stored as the recovery S′ resulting from sleep. In the biological model information, the data of variation in the alertness level according to the elapsed time according to the sleep inertia W is also stored.

The biological rhythm information 42 is data in which information of the biological rhythm relating to the driver's sleep is stored. For example, the biological rhythm information 42 is generated by a generator 102 to be described below.

The controller 82 controls the entire driving management server 10. For the controller 82, an electronic circuit, such as a CPU or a MPU, or an integrated circuit, such as an ASIC or a FPGA, is used. The controller 82 includes an internal memory for storing programs that define various process procedures and control data and executes the various processes according to the program and control data. Various programs run and thus the controller 82 functions as the various processors. For example, the controller 82 includes a collector 100, a driving manager 101, the generator 102 and a provider 103.

The collector 100 collects various types of data. For example, the collector 100 collects the driving information 40 and the status information 41 from the driving monitoring device 11. The collector 100 collects the measurement information 72 from the measuring device 13. The collector 100 stores the collected driving information 40, the status information 41, and the measurement information 72 in the storage unit 81.

The driving manager 101 performs various types of processes relating to management of the driving of the vehicle 12 according to the status information 41 and the measurement information 72.

The generator 102 generates the biological rhythm information 42 relating to the sleep of each driver. For example, by correcting the biological model information 90 according to the measurement information 72, the generator 102 generates the biological rhythm information 42 representing variation in drowsiness to occur to each driver by using the circadian rhythm C, the preceding alertness time S and the sleep inertia W. With respect to each driver, the generator 102 generates the biological rhythm information 42 representing variation in drowsiness to occur to each driver based on the measurement information 72 by using the circadian rhythm C, the preceding alertness time S and the sleep inertia W. For example, the generator 102 generates the alertness level according to the elapsed time from the wake-up time, which is stored in the measurement information 72, by using the data of the preceding alertness time S, which is stored in the biological model information 90. The generator 102 then calculates an elapsed time according to which the alertness level lowers to a level at which drowsiness tends to occur. For example, the generator 102 calculates an elapsed time according to which the alertness level lowers to a threshold corresponding to a drowsiness level or smaller. The generator 102 generates the biological rhythm information 42 in which the elapsed time and the drowsiness level are associated with each other.

The generator 102 may correct the alertness level according to the time band from the wake-up by using the data of the circadian rhythm C that is stored in the biological model information 90. For example, the generator 102 may make a correction to increase the alertness level in daytime and may make a correction to lower the alertness level in nighttime by using the data of the circadian rhythm C.

The generator 102 may correct the alertness level according to the time from the wake-up by using the data of the sleep inertia W stored in the biological model information 90. For example, the generator 102 may correct the alertness level such that the alertness level recovers over time from the wake-up in consideration of the sleep inertia by using the data of the sleep inertial W.

The level of recovery of the alertness level resulting from sleep may be controlled according to the duration of sleep. For example, the generator 102 may make a recovery to the alertness level at the wake-up of the model when the duration of sleep is a predetermined period or longer or make a recovery of the alertness level according to the duration of sleep when the duration of sleep is shorter than the predetermined period. The predetermined time may be set to a time according to which the alertness level recovers sufficiently, such as seven hours. The predetermined time may be set independently for each user.

FIG. 12 is an illustration diagram illustrating exemplary variation in the drowsiness level. The example illustrated in FIG. 12 is the result of estimating the level of drowsiness to occur by using the circadian rhythm C and the preceding alertness time S. In the example illustrated in FIG. 12, the drowsiness level 1 is calculated with respect to a time band A and the drowsiness level 2 is calculated with respect to a time band B.

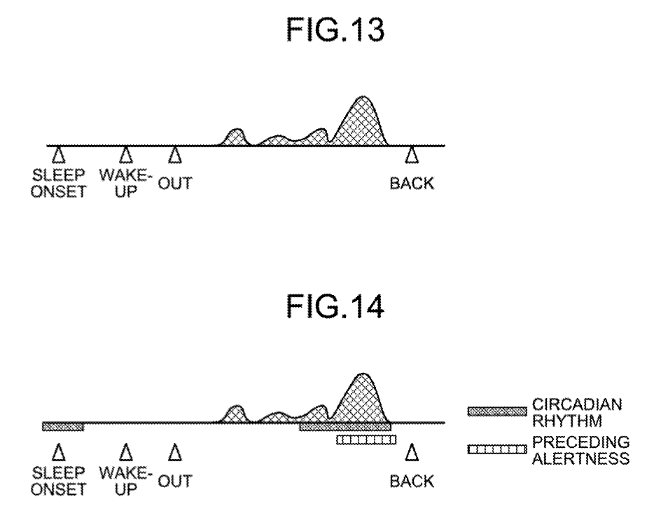

The generator 102 may generate the biological rhythm information 42 by using the status information 41 on the past driving of the vehicle 12 by the driver. For example, the generator 102 may generate the biological rhythm information 42 from the status information 41 on the past driving of the vehicle 12 by the driver according to different driving patterns in which the vehicle is driven. For example, the generator 102 divides 24 hours into a driving pattern from 22 o'clock to 4 o'clock, a driving pattern from 4 o'clock to 10 o'clock, a driving pattern from 10 o'clock to 16 o'clock, and a driving pattern from 16 o'clock to 22 o'clock and calculates variation in the number of times drowsiness occurs from variation in the number of times drowsiness is detected and drowsiness is declared according to each of the driving patterns. The generator 102 may calculate variation in drowsiness also in consideration of near-miss declaration and deviation from the white line. FIG. 13 is an illustration diagram illustrating an example where variation in drowsiness is calculated. The example illustrated in FIG. 13 illustrates the result of tallying the number of times drowsiness occurs. The number of times drowsiness occurs may be tallied at each time band of day or may be tallied at each time band of the elapsed time from the wake-up or the start of driving. The time band during which the number of times is large is a time during which drowsiness tends to occur. For example, the generator 102 calculates an elapsed time according to which the number of times drowsiness occurs increases to a threshold corresponding to the drowsiness level or larger. The generator 102 generates the biological rhythm information 42 in which the elapsed time and the drowsiness level are associated with each other.

The generator 102 may collate the measurement information 72 and the biological model information 90 with each other to generate the biological rhythm information 42. For example, the generator 102 may collate, with variation in the number of times drowsiness occurs, the data of the model of the circadian rhythm C, the preceding alertness time S, and the sleep inertia W in the biological model information 90 to correct the number of times drowsiness occurs according to the alertness level. FIG. 14 is an illustration diagram illustrating an example where variation in drowsiness is calculated. In the example illustrated in FIG. 14, the period in which the alertness level lowers in the circadian rhythm C and the preceding alertness time S is calculated. The generator 102 makes a correction to increase the number of time drowsiness occurs for the period during which the alertness level lowers in the circadian rhythm C and the preceding alertness time S. The generator 102 then calculates an elapsed time according to which the corrected number of times drowsiness occurs increases to the threshold corresponding to the drowsiness level or larger and generates the biological rhythm information 42.

Furthermore, for example, the generator 102 may collate, with variation in the number of times drowsiness occurs, the data of the model of the circadian rhythm C, the preceding alertness time S, and the sleep inertia W in the biological model information 90 and correct the model data. For example, the generator 102 makes a correction to lower the alertness level with respect to the time band during which the number of times drowsiness occurs is large. The generator 102 may generate the biological rhythm information 42 by using the corrected model.

The provider 103 provides the biological rhythm information 42. For example, on receiving a request to transmit the biological rhythm information 42 whose corresponding driver's user ID is specified from the driving monitoring device 11, the provider 103 transmits the requested biological rhythm information 42 corresponding to the user ID of the driver to the driving monitoring device 11 that makes the request. The provider 103 calculates the wake-up time corresponding to the user ID of the driver in the request from the measurement information 72 and notifies the driving monitoring device 11, which makes the request, of the wake-up time.

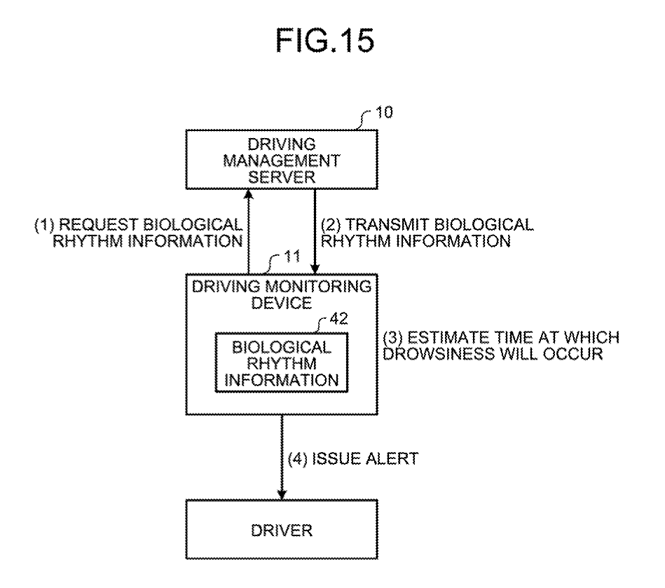

FIG. 15 is an illustration diagram illustrating an exemplary flow of control on alerting. The driving monitoring device 11, for example, specifies the user ID of the driver when driving is started and makes a request for the biological rhythm information 42 to the driving management server 10. The driving management server 10 transmits the biological rhythm information 42 corresponding to the specified user ID to the driving monitoring device 11, which makes the request. The driving monitoring device 11 estimates a time at which drowsiness will occur based on the biological rhythm information 42. The driving monitoring device 11 executes control to cause an output of an alert to the driver, to attenuate the practice standards for outputting an alert, or to increase the level of outputting an alert at a time before the estimated time or at the estimated time. For example, the driving monitoring device 11 outputs an alert alerting that drowsiness tends to occurs at the time the predetermined time before the estimated time. Accordingly, the driver is able to take a preventive measure to, for example, take a rest before drowsiness occurs and therefore it is possible to prevent occurrence of accidents.

Flow of Process

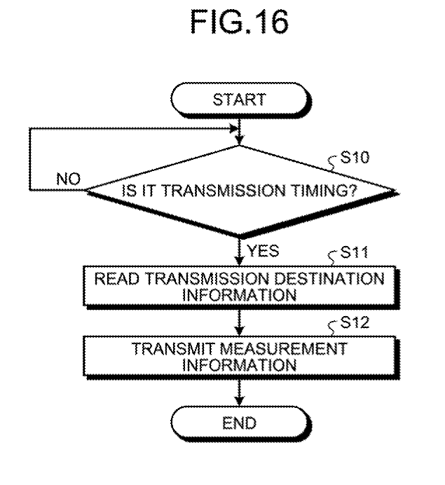

Various processes executed by the system 1 according to the embodiment will be described. First of all, a transmission process performed by the driving management server 10 according to the embodiment to transmit the measurement information 72 to a transmission destination that is registered in the transmission destination information 71 will be described. FIG. 16 is a flowchart illustrating an exemplary procedure of the transmission process. The transmission process is executed repeatedly each time the process ends.

As illustrated in FIG. 16, the controller 65 determines whether it is a predetermined transmission timing (S10). The transmission timing may be a timing at every predetermined period, such as time and date, a timing at which the user or the driving management server 10 issues a transmission instruction, or a timing at which biological information is measured. When it is not the transmission timing (NO at S10), the controller 65 moves to S10 again.

When it is the transmission timing (YES at S10), the controller 65 reads the transmission destination information 71 (S11). The controller 65 transmits the measurement information 72 to the transmission destination that is registered in the transmission destination information 71 (S12) and ends the process. Accordingly, the measurement information 72 is collected by the driving management server 10.

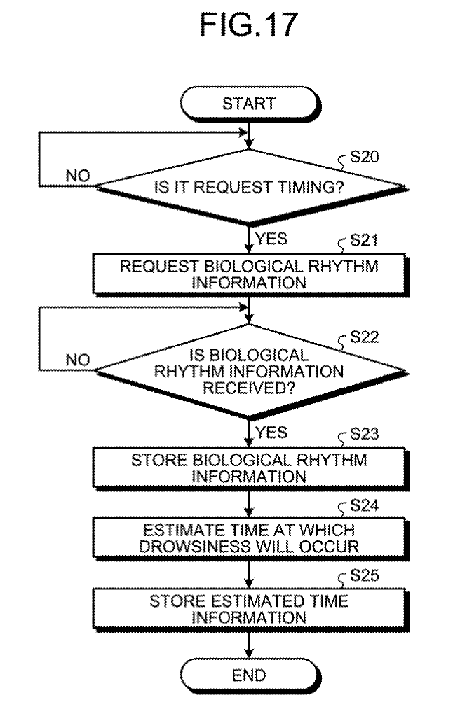

The flow of a request process performed by the driving monitoring device 11 according to the embodiment to make a request for the biological rhythm information 42 will be described. FIG. 17 is a flowchart of an exemplary procedure of the request process. The request process is repeatedly executed each time the process ends.

As illustrated in FIG. 17, the request unit 52 determines whether it is a predetermined request timing (S20). The request timing may be, for example, a timing at which the user ID is read from the contactless IC card or may be a timing at which an operation to start driving is performed. When it is not the request timing (NO at S20), the process moves to S20 again.

On the other hand, when it is the request timing (YES at S20), the request unit 52 transmits a request to transmit the biological rhythm information 42 in which the user ID of the driver is specified to the driving management server 10 (S21). The request unit 52 determines whether the biological rhythm information 42 is received (S22). When the biological rhythm information 42 is not received (NO at S22), the request unit 52 moves to S22 again where the request unit 52 waits for the receiving of the biological rhythm information 42.

On the other hand, when the biological rhythm information 42 is received (YES at S22), the request unit 52 stores the received biological rhythm information 42 in the storage unit 36 (S23). The estimator 53 estimates a time at which drowsiness will occur according to the biological rhythm information 42 (S24). The estimator 53 stores the estimated time and the drowsiness level in association with each other in the estimated time information 43 (S25) and ends the process.

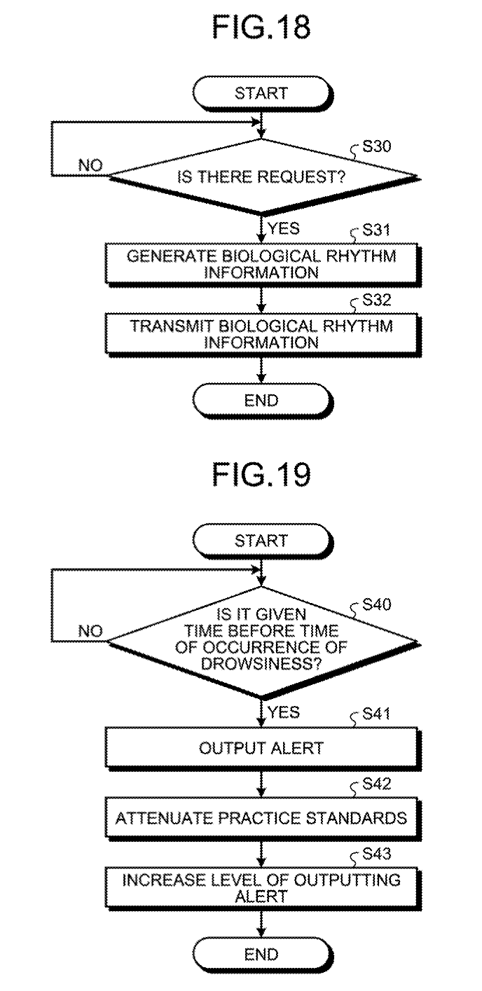

A flow of a generation process performed by the driving monitoring device 11 according to the embodiment to generate the biological rhythm information 42 will be described. FIG. 18 is a flowchart illustrating an exemplary procedure of the generation process. The generation process is executed repeatedly each time the process ends.

As illustrated in FIG. 18, the provider 103 determines whether the request to transmit the biological rhythm information 42, in which the user ID is specified, is received from the driving monitoring device 11 (S30). When the transmitting request is not received (NO at S30), the provider 103 moves to S30 again.

On the other hand, when the transmitting request is received (S30), the generator 102 generates the biological rhythm information 42 on the sleep of the driver having the received user ID (S31). The provider 103 provides the generated biological rhythm information 42 to the driving monitoring device 11, which transmits the request, (S32) and ends the process.

The above-describe degenerating process exemplifies the case where, when the transmitting request is received, the generator 102 generates the biological rhythm information 42; however, the embodiments are not limited thereto and modifications may be made as appropriate. For example, the generator 102 may generate the biological rhythm information 42 at a predetermined generation timing. The generation timing may be a timing at every predetermined period, such as time and date, or the timing at which the biological rhythm information 42 is received. When the transmitting request is received, the provider 103 chooses the biological rhythm information 42 corresponding to the user ID in the request from the biological rhythm information 42 previously generated and transmits the biological rhythm information 42.

The flow of the alerting control process performed by the driving monitoring device 11 according to the embodiment to make an alert will be described. FIG. 19 is a flowchart illustrating an exemplary procedure of the alerting control process. The alerting control process is executed repeatedly each time the process ends.

As illustrated in FIG. 19, the alerting controller 54 determines whether the current time is a time the predetermined time before any one of the times at which drowsiness occurs, which are times stored in the biological rhythm information 42 (S40). When the current time is not a time the predetermined time before any one of the times at which drowsiness occurs (NO S40), the alerting controller 54 moves to S40 again.

On the other hand, when the current time is a time the predetermined time before any one of the times at which drowsiness occurs (YES S40), the alerting controller 54 executes control to output an alert to the driver (S41). Furthermore, the alerting controller 54 executes control to attenuate the practice standards for outputting an alert (S42). The alerting controller 54 then executes control to increase the level of outputting an alert (S43) and ends the process. When the time of end stored in the estimated time information 43 comes, the alerting controller 54 updates the practice standards in the practice standards information 44 to the status where the drowsiness level is 0.

Effect

As described above, the driving monitoring device 11 according to the embodiment estimates a time at which drowsiness will occur based on the biological rhythm information 42 that is stored in the storage unit 36. The driving monitoring device 11 executes the control to output an alert to the driver, to attenuate the practice standards for outputting an alert, or to increase the level of outputting an alert at a time before the estimated time or at the estimate time. Accordingly, the driving monitoring device 11 is able to prevent occurrence of accidents.

The driving monitoring device 11 according to the embodiment makes an alert at the time the predetermined time before the estimate time. Accordingly, the driving monitoring device 11 is able to make an alert before the driver enters a status dangerous to drive.

The driving monitoring device 11 according to the embodiment enhances the alert display, increases the alert sound, or increases the tactile stimulation to alert. Accordingly, the driving monitoring device 11 is able to make a much enhanced alert to the driver in a status where drowsiness tends to occur.

The driving monitoring device 11 according to the embodiment performs control to increase the level of outputting an alert in a manner that the driving monitoring device 11 causes the alert display to blink, increasing the tone of the alert sound, increases the volume of the alert sound, increases the time during which the alert sound is output, or causes alerting strong vibrations. Accordingly, the driving monitoring device 11 is able to make a much enhanced alert to the driver in a status where drowsiness tends to occur.

The driving monitoring device 11 according to the embodiment stores, in the biological rhythm information 42, the information representing variation in drowsiness according to elapsed times from the wake-up time or the time at which driving starts. The driving monitoring device 11 specifies a time at which drowsiness will occur based on the elapsed time from a time at which a specific driver wakes up and the biological rhythm information that are acquired with respect to the specific driver. Accordingly, the driving monitoring device 11 is able to accurately estimate a time at which drowsiness will occurs to the driver.

The driving management server 10 collects vital sign information on the user from the measuring device 13. The driving management server 10 generates a drowsiness occurrence time pattern with respect to the user based on the collected vital sign information. In response to a request in which a driver is specified from the source of the request, the driving management server 10 provides the drowsiness occurrence time pattern that is generated with respect to the user corresponding to the driver to the source of the request. Accordingly, the driving monitoring device 11 is able to make an alert before drowsiness occurs to the driver, thereby preventing occurrence of accidents.

The driving management server 10 according to the embodiment generates a drowsiness occurrence time pattern by correcting the standards information for drowsiness occurrence time pattern according to the collected vital sign information on the user. Accordingly, the driving management server 10 is able to generate a drowsiness occurrence time pattern corresponding to the user.

### [b] Second Embodiment

The embodiment of the disclosed device has been described above, and the disclosed technology may be implemented in various different modes in addition to the above-described embodiment. Other embodiments covered by the invention will be described below.

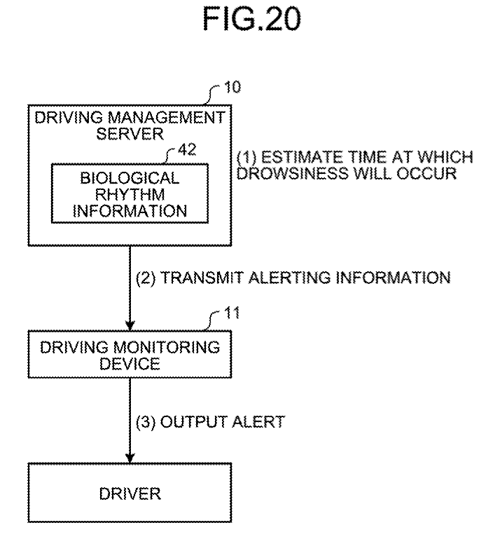

For example, in the above-described embodiment, the driving management server 10 provides the biological rhythm information 42 to the driving monitoring device 11 and the driving monitoring device 11 estimates the time at which drowsiness will occur according to the biological rhythm information 42 and makes an alert at a time before the time of occurrence or at the time of occurrence; however, the embodiments are not limit to this. For example, the driving management server 10 may estimate a time at which drowsiness will occur according to the biological rhythm information 42 and transmit, to the driving monitoring device 11, an instruction to make an alert at a time before the time of occurrence or at the time of occurrence. FIG. 20 is an illustration diagram illustrating another exemplary flow of alerting control. The driving management server 10 estimates a time at which drowsiness will occur according to the biological rhythm information 42. The driving management server 10 transmits an instruction to make an alert to the driving monitoring device 11 at the time of occurrence of drowsiness or the time of occurrence. On receiving the instruction to alert, the driving monitoring device 11 performs control to cause an output of an alert to the driver, control to attenuate the practice standards for outputting an alert, and control to increase the level of outputting an alert. Accordingly, the driver is able to take a preventive measure, such as taking a rest before drowsiness occurs, which prevents occurrence of accidents.

The above-described embodiment exemplifies the case where the practice standards stored in the practice standards information 44 are updated according to the drowsiness level and control is performed to output an alert easily; however, the embodiments are not limited thereto. For example, the alerting controller 54 may perform control where an alerting spot group including more possible spots where alerts are made is used to specify a spot where an alert is made. For example, the driving monitoring device 11 may store attention spot information in which positional information on attention spots to which an attention has to be paid, such as a spot where rapid braking occurs frequently, and an attention level are associated with each other in the storage unit 36. The attention spot information is, for example, transmitted by the driving management server 10 to the driving monitoring device 11. For example, the driving management server 10 generates attention spot information in which positional information on attention spots and attention levels are associated with each other based on the driving information collected from the driving monitoring device 11 and transmits the attention spot information to the driving monitoring device 11. When the drowsiness level is high, the alerting controller 54 performs control to output an alert also with respect to an attention spot at a low attention level. Accordingly, the driving monitoring device 11 is able to call attention to an attention spot at a low attention level when drowsiness tends to occur to the driver, which enables prevention of occurrence of accidents.

The above-described embodiment exemplifies the case where a drowsiness level according to an elapsed time from the driver's wake-up time is calculated; however, the embodiments are not limited thereto, and modifications may be made as appropriate. For example, drowsiness tends to occur when the highly-tensioned state continues. Data of modeled occurrence of drowsiness according to the elapsed time from a time at which driving starts is stored in the biological model information 90. The generator 102 uses the biological model information 90 to store drowsiness levels according to elapsed times from the time at which driving starts in the biological rhythm information 42. The estimator 53 may use the model data in the biological rhythm information 42 to calculate a time at which drowsiness at a drowsiness level occurs and a time at which the drowsiness ends according to the elapsed time from the time at which driving starts. Furthermore, for example, data of modeled occurrence of drowsiness according to the elapsed time from a sleep time at which sleep ends is stored in the biological model information 90. The generator 102 uses the biological model information 90 to store the drowsiness level according to the elapsed time from the sleep time in the biological rhythm information 42. The estimator 53 may use the model data in the biological rhythm information 42 to calculate a time at which drowsiness at a drowsiness level occurs and a time at which drowsiness ends according to the elapsed time from the sleep time.

The above-described embodiment exemplifies the case where the estimator 53 calculates a time at which occurrence of drowsiness at a drowsiness level occurs and a time at which the drowsiness ends; however, the embodiments are not limited thereto, and modifications may be made as appropriate. For example, when the drowsiness level only increases according to the elapsed time, the estimator 53 may estimate only a time at which drowsiness at the drowsiness level will occur.

Furthermore, the embodiment exemplifies the case where the levels of drowsiness to occur according to the elapsed time are stored in the biological rhythm information 42; however, the embodiments are not limited thereto, and modifications may be made as appropriate. For example, the biological rhythm information 42 may be data of a model representing variation in drowsiness. For example, the biological rhythm information 42 may be data of a model of, for example, the circadian rhythm C, the preceding alertness time S, and the sleep inertia S′ illustrated in FIG. 11. The estimator 53 may use the model data in the biological rhythm information 42 to estimate a time at which drowsiness will occur. For example, the biological rhythm information 42 may be information in which the time of occurrence of drowsiness and the level of drowsiness to occur are associated with each other. For example, with respect to each driver, the generator 102 may generate the biological rhythm information 42 representing variation in drowsiness of each driver to occur according to the measurement information 72 by using the circadian rhythm C, the preceding alertness time S, and the sleep inertia S′ and by associating the time at which drowsiness occurs and the drowsiness level to each other. For example, the generator 102 may use the data of the preceding alertness time S stored in the biological model information 90 to generate the biological rhythm information 42 in which a time at which drowsiness occurs after an elapsed time from a wake-up time, which is stored in the measurement information 72, and a level of drowsiness to occur are associated with each other. The estimator 53 may estimate a time of occurrence of drowsiness by reading a time of occurrence of drowsiness corresponding to a drowsiness level from the biological rhythm information 42.

Each of the components of each of the devices illustrated in the drawings is a functional idea and therefore it need not be configured physically as illustrated in the drawings. In other words, the specific mode of dispersion and integration in each device is not limited to that illustrated in the drawings. All or part of the components may be configured in a distributed or integrated manner in a predetermined unit according to various types of loads and the situation in which they are used. For example, each of the storing unit 50, the transmitter 51, the request unit 52, the estimator 53, and the alerting controller 54 of the driving monitoring device 11 may be integrated as appropriate. The collector 100, the driving manager 101, the generator 102, and the provider 103 of the driving management server 10 may be integrated as appropriate. Each process performed by each processor may be divided into processes performed by multiple processors as appropriate. Furthermore, all or part of each processing function implemented by each processor may be implemented by a CPU and a program that is analyzed and executed by a CPU or may be implemented as hardware using a wired logic.

Alerting Control Program

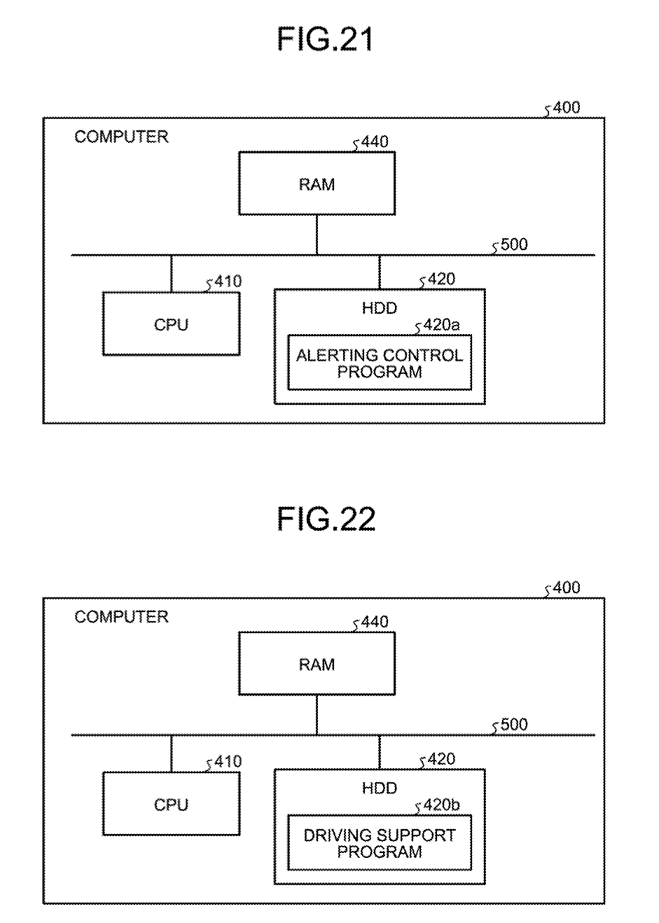

The various processes of the above-described embodiment may be implemented by executing a program, prepared in advance, with a computer system, such as a personal computer or a work station. An exemplary computer system that executes a program having the same functions as those according to the above-described embodiment will be described below. First of all, an alerting control program that controls alerting a driver will be described. FIG. 21 is an illustration diagram illustrating an exemplary configuration of a computer that executes the alerting control program.

As illustrated in FIG. 21, a computer 400 includes a central processing unit (CPU) 410, a hard disk drive (HDD) 420, and a random access memory (RAM) 440. The components 400 to 440 are connected via a bus 500.

An alerting control program 420a that fulfills the same functions as the storing unit 50, the transmitter 51, the request unit 52, the estimator 53, and the alerting controller 54 of the driving monitoring device 11 is stored in the HDD 420 in advance. The alerting control program 420a may be separated as appropriate.

The HDD 420 stores various types of information. For example, the HDD 420 stores an OS and various types of data used to determine an amount of order.

The CPU 410 reads the alerting control program 420a from the HDD 420 and executes the alerting control program 420a and accordingly the same operations as those of the processors of the embodiment are implemented. In other words, the alerting control program 420a executes the same operations as those of the storing unit 50, the transmitter 51, the request unit 52, the estimator 53, and the alerting controller 54.

The alerting control program 420a need not necessarily be stored in the HDD 420 from the beginning.

Driving Support Program

The driving support program that supports driving will be described. FIG. 22 is an illustration diagram illustrating an exemplary configuration of a computer that executes the driving support program. The same components as those in FIG. 21 are denoted with the same reference numerals and descriptions thereof will be omitted.

As illustrated in FIG. 22, a driving support program 420b that fulfills the same functions as those of the collector 100, the driving manager 101, the generator 102, and the provider 103 of the driving management server 10 is stored in the HDD 420 in advance. The driving support program 420b may be separated as appropriate.

The HDD 420 stores various types of information. For example, the HDD 420 stores an OS and various types of data used to determine an amount of order.

The CPU 410 reads the driving support program 420b from the HDD 420 and executes the driving support program 420b and accordingly the same operations as those of the processors of the embodiment are implemented. In other words, the driving support program 420b executes the same operations as those of the collector 100, the driving manager 101, the generator 102 and the provider 103.

The driving support program 420b need not necessarily be stored in the HDD 420 from the beginning.

For example, the alerting control program 420a and the driving support program 420b may be stored in a “portable physical medium”, such as a flexible disk (FD), a CD-ROM, a DVD disk, a magneto-optical disk, or an IC card to be inserted into the computer 400. The computer 400 may read the program from the medium and execute the program.

Furthermore, the programs may be stored in “another computer (or server)” connected to the computer 400 via a public line, the Internet, a LAN or a WAN. The computer 400 may read the programs from the computer (or server) and execute the programs.

The embodiment of the invention has an effect that it possible to prevent occurrence of accidents.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a driving support program that causes a computer to execute a process comprising:
collecting vital sign information on a user from a vital sign measuring device;
generating a drowsiness occurrence time pattern with respect to the user based on the collected vital sign information; and
in response to a request in which a driver is specified from a source of the request, providing the drowsiness occurrence time pattern that is generated with respect to the user corresponding to the driver to the source of the request to the source of request or providing alerting information to the driver that is determined according to the drowsiness occurrence time pattern generated with respect to the user corresponding to the driver to the source of request.

2. The non-transitory computer-readable recording medium according to claim 1, wherein the drowsiness occurrence time pattern is generated by correcting standards information for the drowsiness occurrence time pattern according to the collected vital sign information.

3. A driving support method comprising:
collecting vital sign information on a user from a vital sign measuring device, by a processor;
generating a drowsiness occurrence time pattern with respect to the user based on the collected vital sign information, by the processor; and
in response to a request in which a driver is specified from a source of the request, providing the drowsiness occurrence time pattern that is generated with respect to the user corresponding to the driver to the source of the request or providing alerting information to the driver that is determined according to the drowsiness occurrence time pattern generated with respect to the user corresponding to the driver to the source of request, by the processor.

4. A driving support device comprising:
a processor configured to:
collect vital sign information on a user from a vital sign measuring device;
generate a drowsiness occurrence time pattern with respect to the user based on the vital sign information that is collected by the collecting; and
in response to a request in which a driver is specified from a source of the request, provide the drowsiness occurrence time pattern that is generated with respect to the user corresponding to the driver to the source of the request or provides alerting information to the driver that is determined according to the drowsiness occurrence time pattern generated with respect to the user corresponding to the driver to the source of request.
